(19) United States
(12) Patent Application Publication
(10) Pub. No.: US 2015/0136940 A1
(43) Pub. Date: May 21, 2015

(54) SIESMIC MOUNT

(71) Applicant: Worksafe Technologies, Valencia, CA (US)

(72) Inventors: Gil A. Moreno, San Clemente, CA (US); Donald Hubbard, Valencia, CA (US)

(21) Appl. No.: 14/538,473

(22) Filed: Nov. 11, 2014

Related U.S. Application Data
(60) Provisional application No. 61/903,062, filed on Nov. 12, 2013.

(51) Int. Cl. F16F 1/36; F16M 13/02; F16F 1/02

(52) U.S. Cl. CPC F16F 1/36; F16F 1/02; F16M 13/02
USPC 248/634; 248/560

(57) ABSTRACT

Seismic brackets for retaining an article during an earthquake or other vibration. The seismic brackets comprise at least one fastener component for anchoring the bracket to a stabilizing support structure, one or more connecting member and at least one fastener component for affixing the bracket to a support structure. The connecting member features a U-shaped loop made from a resilient metallic or polymeric material.

### FIELD OF THE INVENTION

The present invention relates to a bracket for securely mounting objects such as, without limitation, one or more article of furniture or equipment or the like to a support surface and, more particularly, to a seismic bracket for flexibly stabilizing workplace, industrial and laboratory equipment and furniture against undesired movement resulting from seismic activity.

### BACKGROUND

Earthquakes occur at cracks in the earth's crust in which shifting tectonic plates build stresses within the crust that cause tremors when they are released. Minor earthquakes are common, with thousands of smaller earthquakes occurring daily, larger magnitude seismic events can cause personal injury, death and property and environmental damage, particularly in heavily populated areas.

While the injury and destruction that may be caused by a major earthquake is obvious, even smaller earthquakes can cause objects to be damaged or become unstable, which in turn may cause personal injury or death. For example, a tall bookcase, cabinet or shelf can topple and/or spill its contents during even small or moderate earthquakes, injuring people in the vicinity, particularly if the furniture or its contents are heavy, or such contents dangerous materials, such as chemicals.

In addition to furniture, many modern workplaces, including offices, medical workplaces and laboratory space, comprise “cubicles”, or modular workplace systems. Such systems provide an excellent means for dividing otherwise large open areas into a plurality of smaller, more functional work spaces. Typically, these systems comprise a plurality of panels joined together in an end-to-end or other angular relationship. Often work surfaces such as desks or laboratory benches, storage cabinets, computers and other objects may be supported by or hung from the wall panels. The wall panels of such modular systems are typically stabilized against undesired movement by being secured to each other and, at times, to a fixed surface such as a wall.

The means for restraining or securing furniture, office systems, workplace, laboratory or industrial equipment, computers and the like to a support structure such as a wall, ceiling, or floor has generally involved the use of rigid braces, brackets or anchors. These rigid fasteners often work well under ordinary working conditions. However, during a large seismic event such brackets and anchors can snap due to the very high shear forces. Additionally, because the brackets are rigid contents of shelves, file cabinets, chemical reagent cabinets, bookcases, and objects resting on top of works surfaces (such as computers and computer monitors) may be broken, damaged, or destroyed by the seismic vibrations themselves without attenuation or cushioning from the full force of the tremor.

Various methods have been attempted to address such problems. Thus, Storch, U.S. Pat. No. 3,353,312 describes an adjustable anchoring means for masonry walls. This anchoring means is said to provide an adjustable connection between, for example a decorative facing wall comprised of brick or stone and an inner masonry wall made of concrete blocks or poured concrete, thus permitting the inner wall to move through settlement of the foundation or vibrations cause by wind or earthquakes. The anchoring means comprises wire elements spaced from one another and embedded into the cement joint between blocks forming the inner wall. Extending along the wires is a bracket that is slidably movable along the wires in a horizontal direction. An anchor to be embedded into the facing wall is mounted on the bracket so as to be slidable in a vertical direction with respect to the bracket, thus compensating for relative movement between the facing wall and the inner wall.

Biggane, U.S. Pat. No. 4,065,218 discloses a seismic brace to keep various independent elements of, or within, a building intact during an earthquake by permitting these elements to move independently. The described device is said to comprise a rigid channel or brace member which is bolted near each end to a pair of plates, wherein each pair of plates are hingedly movable with respect to each other.

Wilcox, U.S. Pat. No. 4,987,708 describes a seismic anchor for mounting an article of furniture to a support surface. The anchor comprises a shank having a head at one end and an abutment spaced longitudinally away from the head, and a fastener secured to the shank between the head and abutment. However, this seismic anchor is configured to securely hold the article in place, and does not appear to compensate for relative movement between the wall and the article of furniture to be secured.

Roth, U.S. Pat. No. 5,188,317 describes a hinged seismic connector for retaining a rod supporting pipes, electrical cables and the like. However, the connector does not appear to compensate for relative movement between the rod and the structure to which the connector is to be secured, except in the direction permitted by the hinge, and along the axis of the rod.

Thompson et al., U.S. Pat. No. 6,050,035 describes a unitized seismic bracket for retaining a support rod. This bracket functions in a manner similar to Roth, but provides a structure capable of affixing the rod to the bracket without disconnecting the rod. However, like Roth, the connector does not appear to compensate for relative movement between the rod and the structure to which the connector is to be secured, except in the direction permitted by the hinge, and along the axis of the rod.

WorkSafe Technologies advertises a bracket, sold under the trademark SeismaFlex™, for securing articles, such as office or worksite furniture and other articles, to walls, or securing office partitions and modular elements to each other. See http://worksafetech.com/pages/SeismaFlex.html (accessed Nov. 12, 2012). The bracket comprises a substantially rectangular sheet of stainless steel having a flat “tongue” portion, followed by a sharp 90° bend and a subsequent shallower 180° “U” bend at one end. This bracket is able to flex, thereby providing for relative vertical movement between the secured article and the wall. However, due to the substantially rectangular shape of the steel sheet comprising the bracket, the bracket does not allow, for example, for twisting and other relative torque movement about the approximate axis of the U-bend itself.

Thus, there remains a need for a seismic bracket that functions to brace and secure articles and structures to each other and which also is able to permit necessary compensatory movement between such articles than are provided by prior brackets, with a suitably wide range of motion in an earthquake, without breaking.

### SUMMARY

The present invention is directed to mounts, such as brackets and the like, for securing home, workplace, industrial and laboratory articles; for example, furniture (including, without limitations, armoires, entertainment centers, bookcases, desks and the like) modular office systems (such as, without limitation, cubicle wall panels, desks or laboratory benches, storage cabinets, computers, etc.), manufacturing and other heavy, valuable, breakable, and/or sensitive equipment, and the like, to a wall or other isolated support structure. The mounts of the present invention are structured to secure the article to the support structure while permitting a significant amount of relative movement between the item to be stabilized and the support structure to which it is affixed. Importantly, the brackets permit compensatory movement when the articles experience an applied torque moment about an axis between the stabilized item and the support structure.

In a basic configuration, the invention comprises a seismic bracket comprising

a) a first fastener component structured to firmly affix an article to be secured;

b) a second fastener component structured to firmly affix the bracket to a support structure; and

c) a connecting portion located between the first fastener component and the second fastener component and comprising a resilient metallic or polymeric strip formed into a substantially U-shaped loop component.

By “fastener component” is meant a structure for firmly affixing the seismic bracket to the indicated article (s) or support structure(s). Such a structure may include, for example, a flat metallic or polymeric plate or “tongue” which can be affixed to a flat surface, such as a tabletop, a wall, a diagonal flat portion of an article to be secured or support structure. Another example of a fastening component may include an annular ring structure which may be tightened or firmly affixed to a cylindrical, polygonal or irregularly shaped portion of an article to be affixed or a support structure, for example, by using a tightening screw, wing nut, socket wrench or the like. Alternatively, the fastening component may be, for example, a flexible metal or polymeric band which may be tightened or firmly affixed to a cylindrical, polygonal or irregularly shaped portion of an article to be affixed or a support structure.

By an “article to be secured” is meant any article intended to be protected and held to a support structure during a seismic tremor. Thus, an article to be secured may be, for example and without limitation) an office furniture or equipment component, a laboratory equipment component, an industrial equipment component. A first article to be secured may in certain circumstances be joined to one or more article to be secured such that each such article acts as a support structure to at least one other article.

By a “support structure” is meant a structure to which an article to be secured is joined to be protected and held to a support structure during a seismic tremor. Typical such structures may be a structural element of a building, such as (without limitation) a wall, framing, plumbing components, joists, and girders. In other embodiments the support structure may comprise the ground or a foundation or floor. In certain circumstances a support structure may comprise an article to be secured, whereby each article to be secured acts as a support structure to at least one other article to be secured.

In a preferred embodiment the present invention is drawn to a bracket comprising, for example, a sheet of metal having high tensile strength, yield strength and elastic modulus, or a durable, strong and flexible polymeric material with similar properties. The bracket of this embodiment has a fastener component comprising a flat “tongue” portion, followed by a sharp 90° bend in the material and a subsequent shallower 180° “U”-bend at one end, resulting in a first, inner flat portion extending at substantially 90° with respect to the tongue portion, and a second flat, outer portion substantially parallel to the first portion comprising a fastener component to affix the bracket to a support structure. Between the first and second flat portion is a connecting portion comprising the portion of the bracket containing the U-bend itself. Preferably, the U-bend comprises a smooth, uniform 180° bend, defining a space between the first and second flat portions. However, in some configurations these angles may differ depending upon the specific spatial requirements of the article to be secured and the support structure. For example, the U-bend of the connecting portion may be somewhat less than 180°, so long as it provides a flexible joint between articles, or between an article and the support structure. Likewise, the support structure and/or article may not be vertical, or may not be flat, and thus the angles of the bracket may be tailored to meet these requirements.

In this embodiment it is particularly preferred (although it may not be preferred in certain other embodiments) that the connecting portion of the bracket contains two, preferably symmetrical notches on either edge of the connecting portion, defining a narrowing or constriction of the width of the connecting portion at the U-bend itself with the narrowest region at the apex of the U-bend. The notches cause the central region of the connecting upper portion comprising the U-bend to preferably have a width of between about ½ and about ⅔ of the width of the un-notched first and second flat portions of the bracket.

The notches preferably define a gently scalloped constriction or narrowing of each edge of the first, inner flat portion and each edge of the second, outer flat portion, with the region of greatest constriction, with relation to the maximum width of each flat portion, being at the apex of the U-bend.

The notches thus preferably provide the connecting portion with a narrower width than the tongue portion and the outer flat portion. This narrower connecting portion permits the bracket to bend around various axes, including an radial axis approximately parallel to the first and second flat portions of the bracket. Not only does this greater range of potential motion more effectively isolate the article to be secured from the full force of the seismic vibration, but the stress of the fastening points is reduced as compared to rigid brackets or fasteners, thus reducing the possibility of the bracket failing during an earthquake.

The tongue portion of the fastener component of the bracket of the present invention preferably comprises a plurality of holes for fastening the tongue of the bracket to the article to be secured. The U-shaped bend in the connecting portion of the bracket results in two substantially flat, substantially parallel portions of the bracket separated from each other by a distance corresponding, for example, to the radius of the U bend. Preferably, each of these parallel portions are provided with at least one hole; the hole in the second, outer flat portion permits a screw, nail, bolt or other fastener to secure the outermost parallel portion (a fastener component) to a wall or vertical surface. Preferably the hole in the innermost parallel portion is an access hole. In one embodiment the hole in the first, inner flat parallel portion has a larger diameter than the hole in the fastener component. The hole in the first flat portion permits the screw or other fastener to be easily placed within the hole in the fastener component without blocking access thereto.

In alternate embodiments, particularly when the mass of the article to be secured is less than about 250 pounds, or less than about 200 pounds, or less than about 150 pounds, or less than about 100 pounds, or less than about 50 pounds the fastener components may be fastened to the article to be secured and/or the supporting structure with a glue, cement, or adhesive bonding tape such as 3M® VHB™ tapes, which contain an acrylic glue to create a permanent “weld”.

The present invention thus comprises a manifest improvement over previously existing seismic brackets. The invention permits dynamic movement of the article to be secured and the supporting structure in many dimensions during an earthquake, resulting in an improved isolation from the full force of the seismic vibration to be experienced by the article to be secured during an earthquake or other substantial vibration, while reducing the possibility of breakage of the bracket at or near the fastening points. Unlike previous seismic brackets depending on a hinge (which generally permits free movement around a single axis of rotation defined by the orientation of the hinge barrel) the present bearing permits movement in three axes and combinations of these axes.

In this embodiment the invention also helps compensate for poorly constructed walls or other vertical support structures, since the U-shaped bend in the connecting portion permits the fastening of items to a wall that may not be at right angles to the floor.

In this embodiment of the invention, the U-bend projects at an angle from the alignment plane of the “tongue” portion of the bracket, thus creating a space between the object to be secured and the supporting structure when the bracket is in place. Depending in part on the size of the bracket, this space may be structured to be, for example, about 0.5 inches, or about 1 inch, or about 1.5 inches, or about 2 inches, or about 2.5 inches, or about 3 inches, or about 3.5 inches or about 4 inches, or about 4.5 inches or more from the supporting structure. In other embodiments this space may be created by placing connecting members between two or more articles to be secured either with or without a distinct additional support structure.

The seismic bracket of the present invention may be scaled up or down as the user wishes, in order to hold items that have greater or lesser mass than the average article of workplace or laboratory furniture or equipment. For example, the dimensions of the seismic bracket may be increased, and the material (for example, steel or other metal alloy) of the bracket may be made thicker, or of a stronger metal or alloy, in order to account for an increase in mass of the article to be secured, and the resulting increase in the forces encountered upon acceleration of the item by seismic vibrations. Such a modification of the specifications of the seismic bracket would cause the flexibility and resiliency of the U-shaped loop of the connecting portion of the bracket to be stiffened significantly, thus requiring greater force to cause the connecting portion to flex during an earthquake. This would be appropriate if the greater mass of the article to be secured results in a substantial increase of the force on the bracket due to the acceleration seen during a significant earthquake.

In typical office or workplace use, the seismic bracket of the present invention may be fabricated to have any convenient dimensions and fastener components tailored to a given application. However, in order to take advantage of the advances conferred by the notches within the U-shaped loop of the connecting portion, the width of the bracket at or near the apex of the loop should be narrow enough to be able to freely flex around the approximate axis formed by the apex of the U-shaped loop. This is a function of factors which may include the width and thickness of the narrowest part of the connecting portion of the bracket, the nature of the material from which the bracket is made, the mass of the article to be secured, and the acceleration conferred upon the item due to a seismic vibration.

For example, brackets for file cabinets, bookcases, and similar furniture may be about 2 inches wide by 4 inches long; for example, a bracket may have the dimensions of about 1½ inches by about 3 inches, and be made from 20 gauge stainless steel. It will be understood that the thickness of various gauges of stainless steel is given in e.g., http://en.wikipedia.org/wiki/Sheet_metalabout (accessed Nov. 19, 2012) and is hereby incorporated by reference. A bracket of these dimensions may provide for a separation between the article to be secured and the supporting structure (e.g., a wall) of about ½ inch. Alternatively, if a space between the object and the supporting structure is desired to be greater, the tongue and/or U-shaped loop portion of the bracket may be made of greater length, and the resulting bracket may have the approximate dimensions of about 2 inches by about 6 inches, for example, about 1½ inches by about 7½ inches. Although the standard brackets are made of 20 gauge stainless steel, any suitable thickness may be used. Similarly, although the bracket of the present invention is preferably made from stainless steel, any material (particularly preferably, any metal or metal alloy) suitable under the circumstances made be used in its place, so long as the material has high tear strength and spring resilience (high yield strength).

Without limitation, examples of circumstances in which a significantly larger bracket might be fabricated and used in accordance with the present invention may involved articles to be secured comprising manufacturing equipment, large-scale fermentation equipment, petroleum distillation and refinery equipment, plumbing structures, building structures (such as joists and beams), laboratory equipment, power plant equipment (including nuclear power plant structures and equipment,), and/or the like. In heavy-duty applications of the sort, the fastening components of the bracket may be affixed to their respective structures in any appropriate manner, such as by welding to the secured item and/or supporting structure, or the use of bolts or other similar structures.

Because in many embodiments the U-shaped loop of the connecting portion of the seismic bracket is bent away from the plane of orientation of the fastener component of the seismic bracket, the U-shaped loop of the bracket may project in any desired orientation, such as upwards or downwards into the space between the article to be secured and the supporting structure created thereby. The U-shaped loop may be made to have a wider or narrower radius, as desired, to create a defined space (at rest) between the item to the secured and the supporting structure to fit, for example, cords, wires, cables and other assemblies.

Consequently, it would be desirable to have a way for securing articles, such as furniture and equipment of various sorts, to a support structure, such as a wall to restrain the article against undesired movement that might result from unexpected structural or tectonic vibrations of unpredictable magnitude, while allowing a degree of relative movement in various directions between the articles.

The examples that follow are intended to illustrate certain embodiments of the invention. However these examples do not limit the scope of the invention, which is defined solely by the claims that conclude this specification.

### BRIEF DESCRIPTION OF THE DRAWINGS

FIG. 1 is drawn to an embodiment of the present invention in which a flat top surface of a single article to be stabilized is secured to a wall surface with a seismic bracket having a fastening component comprising a tongue portion affixed to the article, an inner and outer flat portion joined by a connecting portion having a 180° bend. The connecting portion is constricted at the apex of the bend by two notches at opposing edges of the connecting member. The outer flat portion is a fastening component structured to be affixed to a wall or other flat vertical surface.

FIG. 2A shows another embodiment of the invention comprising a seismic bracket structured to retain a cylindrical article to be secured.

FIG. 2B shows another embodiment of the invention in which a seismic bracket secures and connects two cylindrical portions of an article to be secured (such as piping and a cylindrical pillar or post, or two articles to be secured to each other.)

FIG. 3A shows an embodiment of the invention comprising a multi-lobed seismic bracket structured to retain a cylindrical portion of an article and an article having a flat top surface in parallel to a common fastener component portion affixed to a wall. In this embodiment each article is directly connected to the latter fastener component via an inner and outer flat portion linked by a connecting portion having an approximately 180° bend. The connecting portion is preferably constricted as shown at the apex of the bend by two notches at opposing edges of the connecting member. The outer flat portion (fastener component) is structured to be affixed to a wall or other flat vertical surface.

FIG. 3B shows an embodiment of the invention in which comprising a multi-lobed seismic bracket structured to retain two cylindrical portions of an article to be secured in series; wherein a first connecting portion joins the cylindrical articles and the second connecting portion connects the innermost cylindrical portion to an outer fastening component (flat portion). In this embodiment the first cylindrical portion is only indirectly connected to the fastener component securing the bracket to the wall. Each of the first and second connecting portions of this embodiment have an approximately 180° U-bend, which may project upward, downward, or to the side, as desired. Each connecting portion is constricted at the apex of the U-bend by two notches at opposing edges of the connecting member. The outer flat portion is a fastener component structured to be affixed to a wall or other flat vertical surface.

FIG. 3C shows another embodiment of a seismic bracket of the present invention.

### DETAILED DESCRIPTION OF THE INVENTION

The present invention is directed to compositions and methods for fastening and securing home, office, industrial and workplace items, such as furniture (including, without limitations, armoires, entertainment centers, bookcases, desks and the like) modular office systems (such as, without limitation, cubicle wall panels, desks or laboratory benches, storage cabinets, computers, etc.), manufacturing, refinery, power plant and other valuable, breakable, and/or sensitive equipment, and the like, to a support structure such as a wall, beam joist, or other support structure.

In a preferred embodiment the invention is directed to mounts, such as brackets or anchors, capable of firmly securing an article to be secured to a support structure, whereby the bracket is substantially flexible in three dimensions. Such flexibility is advantageous for preventing or reducing both the article to be secured, and the bracket itself, from experiencing the full force of a seismic shock. In particular, the brackets of (and used in the methods of) the present invention are flexible in a manner permitting side to side relative movement between the article to be secured and the support structure around the axis of the bracket itself.

The brackets of the present invention all have the feature of a U-shaped bend in a connecting portion between a first and second fastener component. The connecting portion is preferably made from a hard, resilient material having a high yield strength, impact strength, tensile strength and/or elastic modulus; preferably a metal or metal alloy such as stainless steel or phosphor bronze alloys.

In a particularly preferred embodiment the bracket is made from a single flat sheet of a hard, resilient material. A proximal end of the sheet preferably comprises a fastener component, such as a flat “tongue” portion, for affixing either to the article to be secured or to the supporting structure. However, those of skill in the art will be aware of myriad ways in which the bracket may be attached, both to the article to be secured and to the supporting structure.

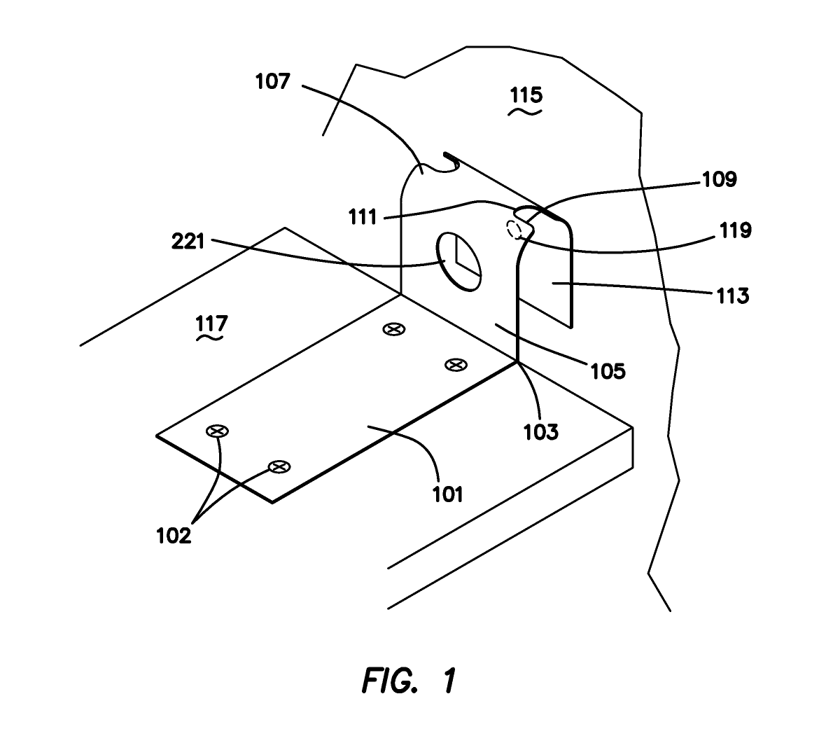

Thus, one preferred embodiment of the present invention is shown in FIG. 1. In this Figure the fastener component (tongue portion) (101) is flat and comprises a plurality of holes (102) for screwing or bolting the tongue region to the article to be secured (117), in this case the top of a table or work surface. The flat sheet of metal then bends approximately 90° upward from the plane of the tongue region (103) to form a first inner flat portion (105) extending at substantially 90° with respect to the tongue portion (101). This first flat portion extends upward and then bends approximately 180° (in a “U-bend”) to form a second, outer flat portion (113); the second flat portion (fastener component) preferably contains one or more hole (119) for affixing the outer portion to a substantially vertically extending supporting structure such as a wall (115). In a particularly preferred embodiment the second flat portion (113) comprises a single hole (119) for affixing to the supporting structure (115); this permits the bracket as a whole to rotate around this affixing point during an earthquake or other event causing relative movement between the support structure (115) and the article to be secured (117). Additionally, the first flat portion has a larger hole through which a screw, nail, bolt, or other similar joining means may be inserted into the fastener component.

The top of the U-shaped bend comprises a notch (109) on either opposing edge of the connecting portion (107), resulting in a constriction of the width of the connecting portion at the U bend itself. This modification permits the U-shaped bend itself to flex, thus permitting the article to be secured (117) to move toward the supporting structure (115) on one side of the bracket, while moving away from the supporting structure on the other side of the bracket.

As shown, the tongue portion (fastener component) (101) comprises a plurality of holes (102) for screwing or bolting the tongue region to the article to be secured (117). However, in the embodiment shown, any suitable method for firmly securing the fastener component of the bracket to the article to be secured is envisioned. Thus, the fastener component may be affixed using, without limitation, a glue or other bonding agent, may be welded in a manner causing a weld pool and coalescence, or a strong adhesive tape such as 3M® VHB™ tapes, which contain an acrylic glue to create a permanent polymeric “weld”, may be used.

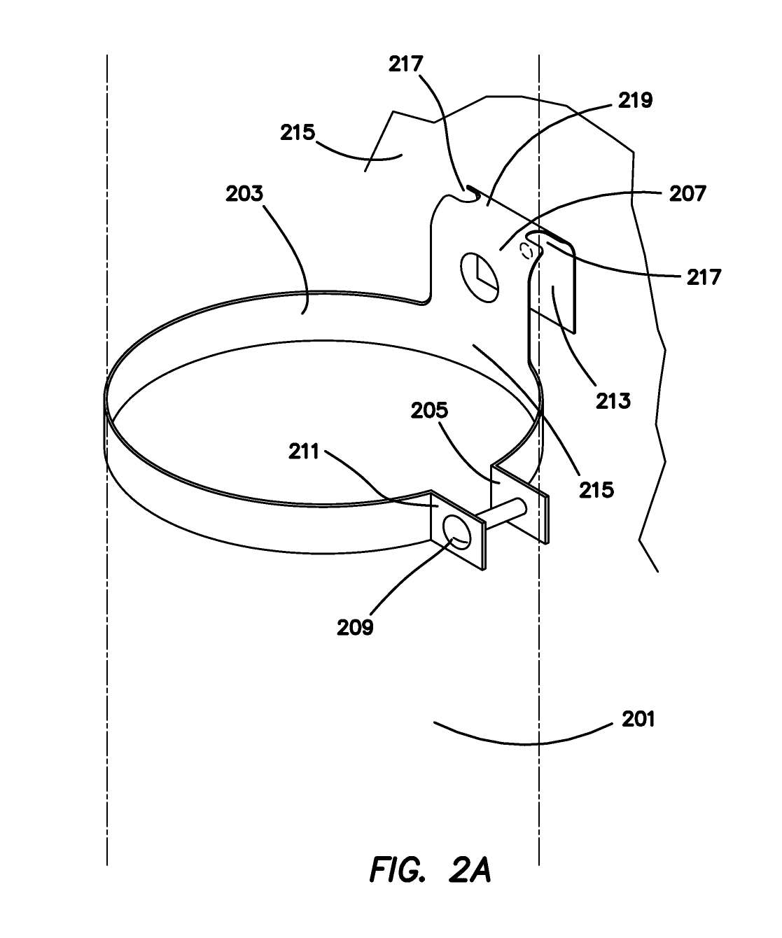

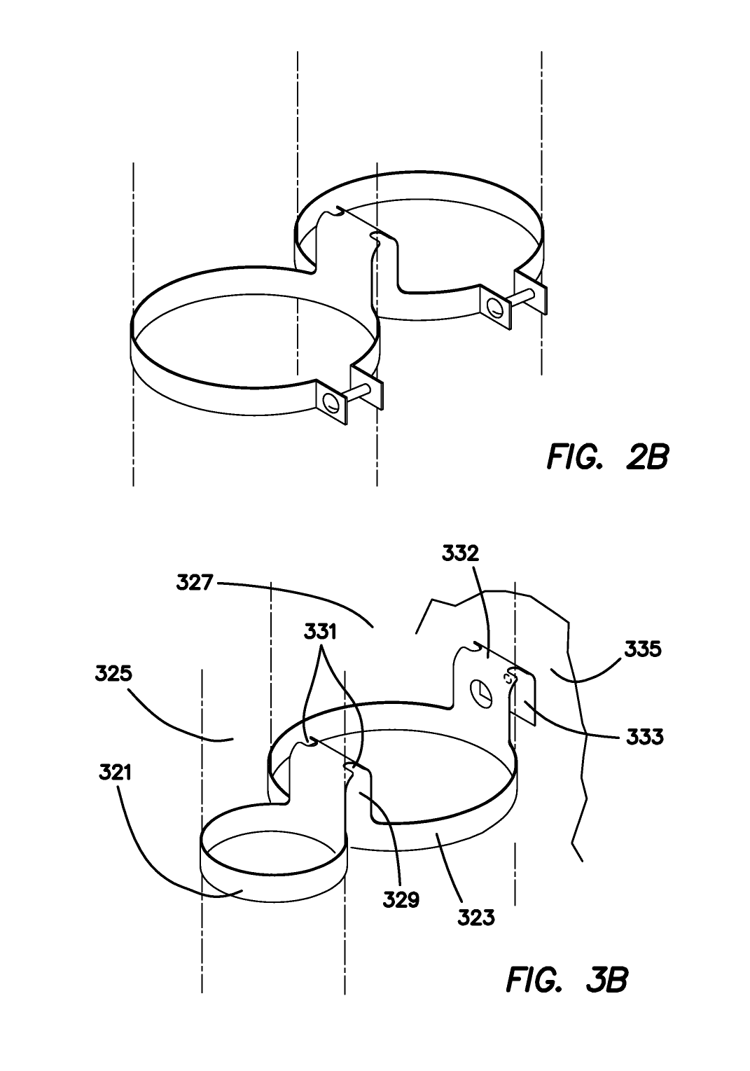

It will be appreciated that the seismic bracket of the present invention may be fastened to the article to be secured, and to the supporting structure, in any suitably “permanent” way. For example, without limitation, FIG. 2A illustrates another embodiment of the invention for retaining an article to be secured wherein the item comprises, for example, a wholly or partly tubular or cylindrical feature. In this embodiment, the fastener component or modified from a “tongue” to contain or comprise one or more annular ring component (203) structured to encircle the tubular or cylindrical portion (201) of the article to be secured. The annular band component preferably can be loosened or opened to permit the cylindrical component to be encircled thereby, and then closed and/or tightened to secure the seismic fastener to the article to be secured. For example, in one embodiment the annular band component comprises an opening having a first end portion (205) and a second end portion (211) and a means for connecting and/or tightening the end portions which can cause the first and second end portions to be brought closer together or farther from each other. For example, in FIG. 2A, a turnbuckle or screw (209) can be used in conjunction with threaded holes or slots at or near the end of the first and second annular band portions to loosen or tighten the fastener component.

In this embodiment of the present invention, the segment of the annular band portion (217) closest to the supporting structure (215) is modified to bend upward (shown) or downward into the U-shaped bend of the connecting portion (207) of the fastener. In this embodiment preferably, but not necessarily, the apex of the U-bend contains a notch (217) on either opposing edge of the connecting portion (207), resulting in a constriction or narrowing of the width of the connecting portion at the U bend itself (219). This modification permits the U-shaped bend itself to flex around the axis of this construction, thus permitting the article be secured (201) to move or twist with respect to the supporting structure (215).

Also, in this embodiment the distal end of the seismic bracket is shaped into a fastener component in a manner similar to that of the second, outer flat portion of a previously described embodiment (213), which is then affixed to a support structure, such as a wall or other level surface (215).

When both the article to be secured and the support structure have a cylindrical or tubular portion in the same orientation, the fastener may comprise two annular bands as securing means to both the article and the supporting structure; see e.g., FIG. 2B. In certain embodiments illustrated by this figure each article to be secured acts as a support structure as well, and vice versa.

Moreover, a fastener component encircling or surrounding an article to be secured or a supporting structure may be tailored to fit the shape if the article to be secured as an irregular or unusual shape. For example, the fastener component may comprise a flexible polymeric or metal band which can assume the shape of a portion of the article to be secured and/or support structure, thereby securing said article and/or support structure.

As mentioned previously, although the seismic brackets of the present invention were originally invented in conjunction with relatively lightweight articles such as workplace and office furniture and articles, the brackets may be scaled to secure an article of any desired spatial orientation, size or mass. Thus, the brackets of the present invention may be used in building construction to fasten together structural elements of a building, such as (without limitation) framing, plumbing, joists, and girders, while permitting the linkage the ability to flex in several dimensions. The seismic brackets of the present invention may also be used to support and secure heavy equipment, such as manufacturing, refinery, power plant and/or other similarly heavy equipment to a suitable supporting structure, such as one or more building beam, girder, or other support structure, where they may be scaled up as required.

As can be readily envisioned by a person of ordinary skill in the art, the mount of the present invention may comprise a seismic brace or bracket having multiple specific structures. In certain embodiments, the seismic bracket of the present invention may comprise a multi-lobed structure comprising more than one U-bend, for example for securing more than one article, or for flexibly holding a plurality of items together. Preferably, although not invariably, the multi-lobed seismic brackets of the invention comprise U-bends having a pair of notches along each side of the connecting portion of each side of the apex of the U-bend. In a particular embodiment, the multi-lobed brackets of the invention comprise a pair of opposing notches along each side of the connecting portion, with the position of greatest constriction being at the apex of the U-bend. In another embodiment the multi-lobed brackets of the invention do not comprise a pair of notches along each side of the connecting portion of each side of the apex of the U-bend.

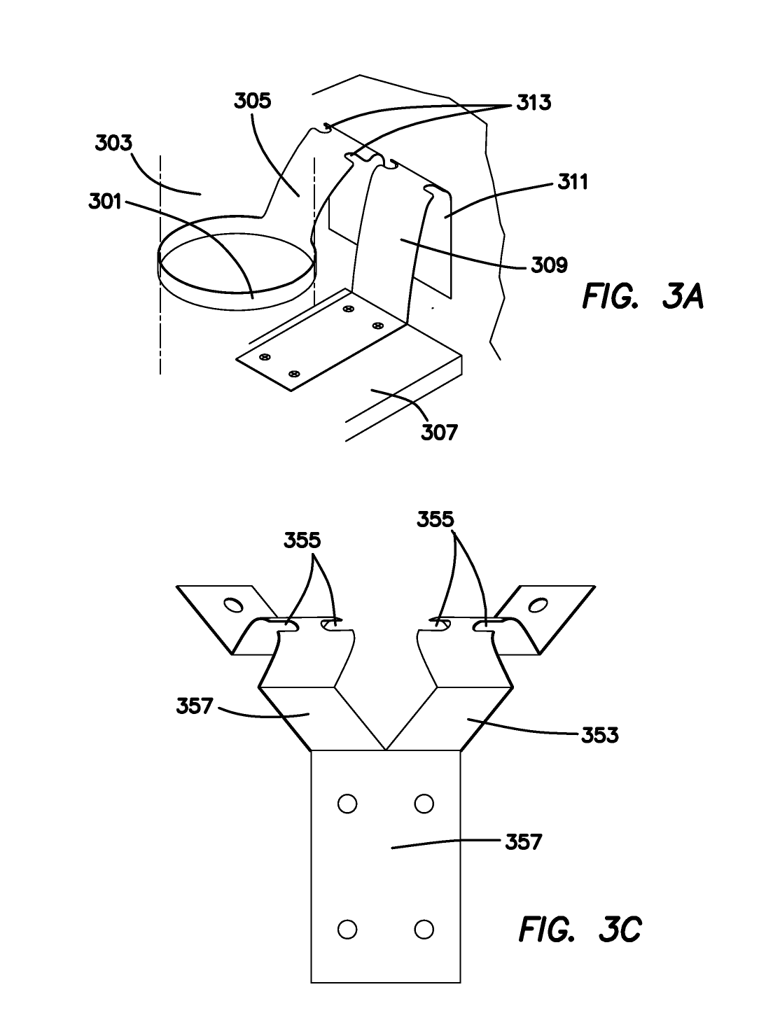

FIG. 3A shows a seismic bracket of the present invention in which an article having a cylindrical portion to be secured (303) is held by a fastener component comprising an annular ring component (301) to a fatsener component (outer flat plate portion) (311) secured to a wall (315) via a first connecting portion (305) comprising a U-bend with a pair of notches (313) on opposing edges of the apex thereof. It will be understood that the cylindrical portion may be held by any convenient and suitable fastener component other than, or in addition to the annular ring component. For example, the seismic bracket of the present invention may alternatively be held by welding, bonding, or riveting a metallic or polymeric plate or strip to the surface of the cylindrical article in place of the circumferential band. Additionally, while the cylindrical article is shown in a vertical orientation in FIG. 3A, the bracket may be manufactured or adapted to conform to hold cylindrical articles (or portions thereof) having any desired resting orientation.

In this embodiment of the invention, another article to be secured comprises a flat surface portion (307) such as a tabletop, desktop or the top surface of a cabinet. The flat surface portion is joined to a second fastener component (flat plate portion) (311) via a second connecting portion (309). This also comprises a U-bend having a pair of opposing notches on the outside edges of the apex of the U-bend. In other embodiments of the invention the single flat plate portion (311) may comprise discontinuous first and second fastener components (flat plate portions). Although the flat surface portion (307) is shown in a horizontal orientation, the seismic bracket may be manufactured or adapted to hold an article having a flat surface in any desired resting orientation.

FIG. 3B shows yet another embodiment of the invention, in which first and second cylindrical articles to be secured (325) and (327), respectively) are held by fastener components comprising first and second annular bands (321) and (323), respectively. The first and second annular bands are joined by a first connecting portion (329) having a U-bend with a pair of notches (331) on opposing edges at the apex thereof. The notches are not required in all embodiments of the invention. The second annular band (323) is joined to a plate portion (333) by a second connecting portion (332), which is, in turn, fastened to a support structure, in this case, a wall (335). The second connecting portion is also formed into a U-bend in which the apex of the U-bend preferably comprises a pair of notches on opposing edges of the connecting portion thereof. Thus, the seismic bracket of this embodiment of the invention secures two articles having cylindrical portions, permitting each article to independently move in response to a seismic event with respect to the wall to which they are secured, as well as with respect to each other. It will be understood that, although both articles are shown with cylindrical portions having the same vertical orientation, the seismic bracket may be manufactured or configured to hold articles having non-vertical and/or different orientations with respect to each other.

FIG. 3C shows a further embodiment of the invention comprising a dual-lobed seismic bracket configured to hold an article to be secured having a flat vertical surface such side surface of a cabinet or article of machinery between two supporting structures, such as roofing beams or rafters, studs, joists, braces and the like. The seismic bracket of this embodiment of the invention comprises a first and second connecting members (351) and (353), respectively), each modified to bend upward (shown) or downward into a U-shaped bend. In this embodiment preferably, but not necessarily, the apex of the U-bend contains a notch (355) on either edge of the connecting portion, resulting in a constriction of the width of the connecting portion at the U bend itself. Each connecting member is joined to a fastener component (in this case, a tongue portion (357)) for fastening to the article to be secured.

The person of ordinary skill in the art will immediately recognize in view of the present disclosure that an extremely large number of embodiments of the invention not expressly illustrated or exemplified herein will immediately be apparent. Thus, in some embodiments of the invention the seismic brackets may be increased in scale to hold, for example (and without limitation), large ducting or piping, large equipment, such as manufacturing, refinery, power plant, computer and other equipment. Additionally, such a person will conceive, for example (and without limitation), of embodiments of the present invention comprising multi-lobed seismic brackets having three or more connecting members, either in series (with “U-bend”-comprising connecting members directly linking three or more articles to be stabilized) or in parallel (with three or more “U-bend”-comprising connecting members directly linked to a stabilizing fastener component). All these and additional embodiments are included within the scope of the invention, which is limited only by the claims which conclude this specification.

Each patent, patent application, website or other publication cited in this patent application is hereby individually incorporated by reference in its entirety as part of this specification.

While the present claims disclose certain specific embodiments of the invention, it is expressly intended that this specification contains a complete written description, inter alia, of any embodiment of the invention containing or lacking any claim limitation, or any and all combinations of the claim limitations, appearing in the claims, whether initially presented in independent claims or dependent claims. The nature of the present invention is such that the knowledge and level of skill in the art would permit one of ordinary skill in the art to immediately envisage any such embodiment subsequently claimed.

We claim:

1) A seismic bracket comprising:
a) a first fastener component structured to firmly affix an article to be secured;
b) a second fastener component structured to firmly affix the bracket to a support structure; and
c) a connecting portion located between the first fastener component and the second fastener component and comprising a resilient metallic or polymeric strip formed into a substantially U-shaped loop component; wherein the U-shaped loop component comprises a constriction in the width of the resilient strip having a region of greatest narrowing substantially located at the apex of the U-shaped loop.

2) The seismic bracket of claim 1 wherein the first fastening component comprises a flat plate comprising a metallic or polymeric material structured to be affixed to a flat surface of the article to be secured.

3) The seismic bracket of claim 1 wherein the first fastening component comprises an annular band component structured to fit and securely constrain a substantially cylindrical component of the article to be secured.

4) The seismic bracket of claim 1 wherein the second fastening component comprises a flat plate comprising a metallic or polymeric material structured to be affixed to a flat surface of the supporting structure.

5) The seismic bracket of claim 1 wherein the second fastening component comprises an annular band component structured to fit and securely constrain a substantially cylindrical component of the supporting structure.

6) The seismic bracket of claim 2 wherein the second fastening component comprises a flat plate comprising a metallic or polymeric material structured to be affixed to a flat surface of the supporting structure.

7) The seismic bracket of claim 2 wherein the second fastening component comprises an annular band component structured to fit and securely constrain a substantially cylindrical component of the supporting structure.

8) The seismic bracket of claim 4 wherein the first fastening component comprises a flat plate comprising a metallic or polymeric material structured to be affixed to a flat surface of the article to be secured.

9) The seismic bracket of claim 5 wherein the first fastening component comprises a flat plate comprising a metallic or polymeric material structured to be affixed to a flat surface of the article to be secured.

10) The seismic bracket of claim 1 wherein the first fastening component, the second fastening component and the connecting portion are parts of a single metallic or polymeric material.

11) The seismic bracket of claim 10 wherein the first fastening component, the second fastening component and the connecting portion are parts of a single metallic sheet.

12) The seismic bracket of claim 2 comprising a first substantially flat portion between the first fastening component and the connecting portion, and wherein the first substantially flat portion bends at approximately 90° to the plane of the first fastening component.

13) The seismic bracket of claim 12 comprising a second substantially flat portion directly joined to the connecting portion and oriented by the U-shaped bend of the connecting portion to be substantially parallel to the first substantially flat portion.

14) The seismic bracket of claim 13 wherein the second substantially flat portion comprises the second fastener component.

15) The seismic bracket of claim 1 wherein the second fastener component is structured to be affixed to a flat vertical surface at a single attachment point.

16) The seismic bracket of claim 15 wherein the second fastener component is structured to be affixed to a flat vertical surface at a single attachment point around which the bracket is rotatable during a seismic tremor.

17) The seismic bracket of claim 1 wherein the article to be secured is selected from the group consisting of home or office furniture, modular workplace system components, laboratory equipment, chemical reagent cabinets, and industrial equipment.

18) A seismic bracket comprising:
a) a first fastener component structured to firmly affix an article to be secured;
b) a second fastener component structured to firmly affix the bracket to a support structure; and
c) a connecting portion located between the first fastener component and the second fastener component and comprising a resilient metallic or polymeric strip formed into a substantially U-shaped loop component, wherein at least the first fastener component or the second fastener component is not a flat plate comprising a metallic or polymeric material structured to be affixed to a flat surface.

19) The seismic bracket of claim 1 wherein the first fastener component comprises a flat plate comprising a metallic or polymeric material structured to be affixed to a flat surface of the article to be secured.

20) The seismic bracket of claim 19 wherein the first fastening component comprises an annular band component structured to fit and securely constrain a substantially cylindrical component of the article to be secured.

21) The seismic bracket of claim 19 wherein the second fastening component comprises a flat plate comprising a metallic or polymeric material structured to be affixed to a flat surface of the supporting structure.

22) The seismic bracket of claim 19 wherein the second fastening component comprises an annular band component structured to fit and securely constrain a substantially cylindrical component of the supporting structure.

23) A seismic bracket comprising:
a) a first fastener component structured to firmly affix an article to be secured;
b) a second fastener component structured to firmly affix the bracket to a support structure;
c) a third fastener component; and
d) at least one connecting portion located between the article to be secured and the support structure, each such connecting portion comprising a resilient metallic or polymeric strip formed into a substantially U-shaped loop component.

24) The seismic bracket of claim 23 wherein the third fastening component is structured to firmly affix an article to be secured.

25) The seismic bracket of claim 24 wherein the third fastening component is joined to the first fastener component by a connecting portion.

26) The seismic bracket of claim 25 wherein each article to be secured is also a support structure.

27) The seismic bracket of claim 24 wherein the third fastening component is joined to the second fastening component by a connecting portion.

28) The seismic bracket of claim wherein the first fastening component and the third fastening component are each joined to the second fastening component by different connecting portions.

25) The seismic bracket of claim 23 wherein the third fastening component is structured to firmly affix a support structure.

25) The seismic bracket of claim 23 wherein the second fastening component and third fastening component are each joined to different connecting portions.

26) The seismic bracket of claim 25 wherein the second fastening component and third fastening component are each joined to different support structures.

27) The seismic bracket of claim 23 wherein the U-shaped loop component of at least one connecting portion comprises a constriction in the width of the resilient strip substantially located at the apex of the U-shaped loop.

28) The seismic bracket of claim 23 wherein the U-shaped loop component of each connecting portion comprises a constriction in the width of the resilient strip having a region of greatest narrowing substantially located at the apex of the U-shaped loop.
